(19) United States
(12) Patent Application Publication
(10) Pub. No.: US 2002/0138593 A1
(43) Pub. Date: Sep. 26, 2002

(54) Methods and systems for retrieving, organizing, and playing media content

(76) Inventors: Michael J. Novak, Redmond, WA (US); Geoffrey Harris, Seattle, WA (US); Kipley J. Olson, Seattle, WA (US)

Correspondence Address: LEE & HAYES PLLC, 421 W RIVERSIDE AVENUE SUITE 500, SPOKANE, WA, 99201

(21) Appl. No.: 09/817,801

(22) Filed: Mar. 26, 2001

(51) Int. Cl. G06F 15/16; G06F 13/12; G06F 13/38

(52) U.S. Cl. 709/219; 709/231; 710/69

(57) ABSTRACT

Innovative techniques, systems and methods are described that enable media content to be packaged and delivered, via a network, in a manner that can greatly enhance the user experience. A packaging approach provides a downloadable file that contains different constituent parts that can be processed by a software-implemented media player to provide a user with not only media content, but additional content that adds value to the media content. In addition, in some embodiments, a download approach provides for the downloadable file to be link-accessed by a user, and automatically downloaded, cataloged, and experienced by the user without any more user intervention other than clicking on a particular link that is associated with the downloadable file.

### TECHNICAL FIELD

This invention relates to methods and systems for retrieving, organizing, and playing media content.

### BACKGROUND

Today, individuals are able to use their computers to download and play various media content. For example, many companies offer so-called media players that reside on a computer and allow a user to download and experience a variety of media content. For example, users can download media files associated with music and listen to the music via their media player. While users can derive enjoyment from this model, the user experience is really not all that it could be. For example, while users can download music files, they often miss out on a complete user experience such as the one experienced by an individual who purchases a physical CD. This latter individual can now not only listen to their music, but can read song lyrics, learn interesting new facts about the band or artist from the CD jacket, enjoy the CD jacket art, be exposed to information that can facilitate purchasing experiences (e.g. a web site that the user can type into their browser and access), and discover seemingly limitless information relating to their new CD.

In addition, the above described content download model falls short of providing content providers and others, with opportunities to fully market their goods, position their products, and otherwise add value to the end user's experience.

Accordingly, this invention arose out of concerns associated with providing improved methods and systems for organizing, retrieving, and playing media content.

### SUMMARY

Innovative techniques, systems and methods are described that enable media content to be packaged and delivered, via a network, in a manner that can greatly enhance the user experience. A packaging approach provides a downloadable file that contains different constituent parts that can be processed by a software-implemented media player to provide a user with not only media content, but additional content that adds value to the media content. In addition, in some embodiments, a download approach provides for the downloadable file to be link-accessed by a user, and automatically downloaded, cataloged, and experienced by the user without any more user intervention other than clicking on a particular link that is associated with the downloadable file.

### BRIEF DESCRIPTION OF THE DRAWINGS

FIG. 1 is block diagram of an exemplary system in which various embodiments can be employed.

FIG. 2 is a block diagram of an exemplary server computer.

FIG. 3 is a block diagram of an exemplary client computer.

FIG. 4 is a diagram of an exemplary media player user interface UI in accordance with one embodiment.

FIG. 5 is a block diagram of an exemplary WMD file in accordance with one embodiment.

FIG. 6 is a block diagram of an exemplary skin or border file in accordance with one embodiment.

FIG. 7 is a flow diagram that describes steps in a method in accordance with one embodiment.

FIG. 8 is a block diagram of an exemplary computer architecture that can be utilized to implement various embodiments.

FIG. 9 is a diagram that illustrates a portion of an exemplary .asx file in accordance with one embodiment.

FIG. 10 is a flow diagram that describes steps in a method in accordance with one embodiment.

FIG. 11 is a block diagram that is useful in understanding how a WMD file is processed in accordance with one embodiment.

FIG. 12 is a flow diagram that describes steps in a method in accordance with one embodiment.

FIG. 13 is a block diagram that illustrates one aspect of how digital rights management techniques can be utilized in one embodiment.

### DETAILED DESCRIPTION

### Overview

Innovative techniques, systems and methods are described that enable media content to be packaged and delivered, via a network, in a manner that can greatly enhance the user experience. A packaging approach provides a downloadable file that contains different constituent parts that can be processed by a software-implemented media player to provide a user with not only media content, but additional content that adds value to the media content. In addition, in some embodiments, a download approach provides for the downloadable file to be link-accessed by a user, and automatically downloaded, cataloged, and experienced by the user without any more user intervention other than clicking on a particular link that is associated with the downloadable file.

### Exemplary System

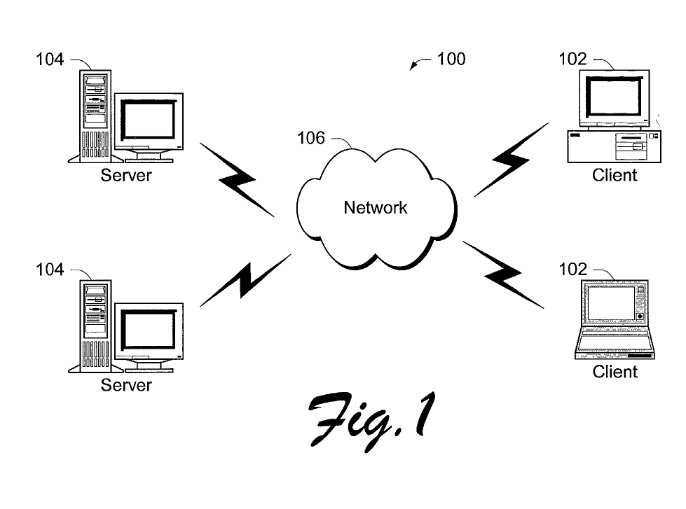

FIG. 1 shows exemplary systems and a network, generally at 100, in which the described embodiments can be implemented. The systems can be implemented in connection with any suitable network. In the embodiment shown, the system is implemented over the public Internet, using the World Wide Web (WWW or Web), and its hyperlinking capabilities. The description herein assumes a general knowledge of technologies relating to the Internet, and specifically of topics relating to file specification, file retrieval, streaming multimedia content, and hyperlinking technology.

System 100 includes one or more clients 102 and one or more network servers 104, all of which are connected for data communications over the Internet 106. Each client and server can be implemented as a personal computer or a similar computer of the type that is typically referred to as “IBM-compatible.”

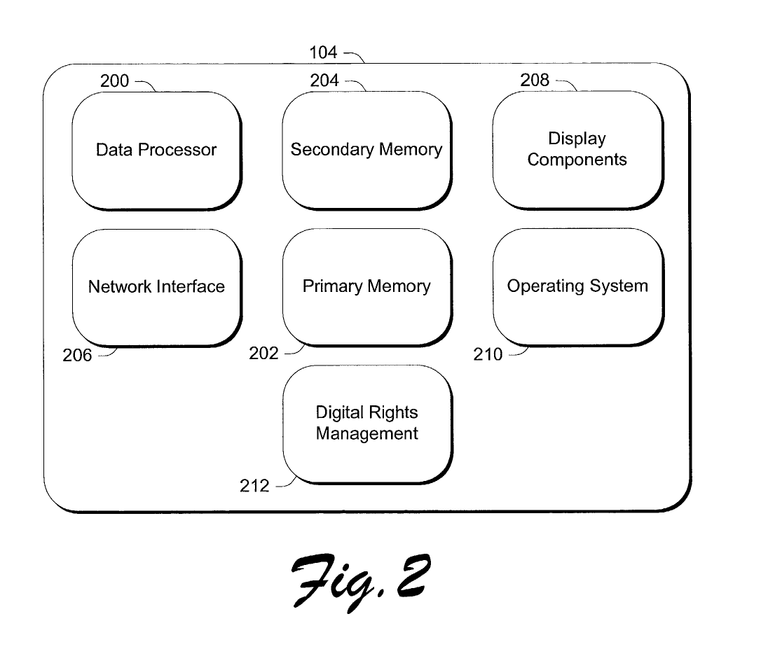

An example of a server computer 104 is illustrated in block form in FIG. 2 and includes conventional components such as a data processor 200; volatile and non-volatile primary electronic memory 202; secondary memory 204 such as hard disks and floppy disks or other removable media; network interface components 206; display devices interfaces and drivers 208; and other components that are well known. The computer runs an operating system 210 such as the Windows NT operating system. The server can also be configured with a digital rights management module 212 that is programmed to provide and enforce digital rights with respect to multimedia and other content that it sends to clients 102. Such digital rights can include, without limitation, functionalities including encryption, key exchange, license delivery and the like.

Network servers 104 and their operating systems can be configured in accordance with known technology, so that they are capable of streaming data connections with clients. The servers include storage components (such as secondary memory 204), on which various data files are stored and formatted appropriately for efficient transmission using known protocols. Compression techniques can be desirably used to make the most efficient use of limited Internet bandwidth.

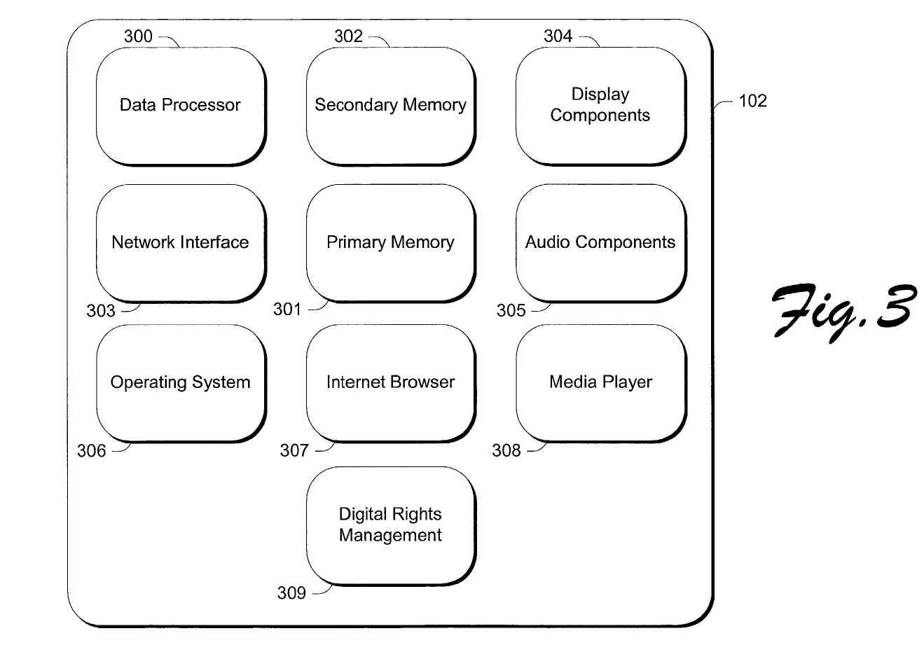

FIG. 3 shows an example of a client computer 102. Various types of clients can be utilized, such as personal computers, palmtop computers, notebook computers, personal organizers, etc. Client computer 104 includes conventional components similar to those of network server 104, including a data processor 300; volatile and non-volatile primary electronic memory 301; secondary memory 302 such as hard disks and floppy disks or other removable media; network interface components 303; display devices interfaces and drivers 304; audio recording and rendering components 305; and other components as are common in personal computers.

In the case of both network server 104 and client computer 102, the data processors are programmed by means of instructions stored at different times in the various computer-readable storage media of the computers. Programs are typically distributed, for example, on floppy disks or CD-ROMs. From there, they are installed or loaded into the secondary memory of a computer. At execution, they are loaded at least partially into the computer's primary electronic memory. The embodiments described herein can include these various types of computer-readable storage media when such media contain instructions or programs for implementing the described steps in conjunction with a microprocessor or other data processor. The embodiments can also include the computer itself when programmed according to the methods and techniques described below.

For purposes of illustration, programs and program components are shown in FIGS. 2 and 3 as discrete blocks within a computer, although it is recognized that such programs and components reside at various times in different storage components of the computer.

Client 102 is desirably configured with a consumer-oriented operating system 306, such as one of Microsoft Corporation's Windows operating systems. In addition, client 102 can run an Internet browser 307, such as Microsoft's Internet Explorer.

Client 102 can also include a multimedia data player or rendering component 308. An exemplary multimedia player is Microsoft's Media Player 7. This software component can be capable of establishing data connections with Internet servers or other servers, and of rendering the multimedia data as audio or video.

Player 308 can be implemented in any suitable hardware, software, firmware, or combination thereof. In the illustrated and described embodiment, it can be implemented as a standalone software component, as an ActiveX control (ActiveX controls are standard features of programs designed for Windows operating systems), or any other suitable software component.

In the illustrated and described embodiment, media player 308 is registered with the operating system so that it is invoked to open certain types of files, discussed in more detail below, in response to user requests. In the Windows operating system, such a user request can be made by clicking on an icon or a link that is associated with the file types. For example, when browsing to a Web site that contains links to certain music for purchasing, a user can simply click on a link. When this happens, the media player can be loaded and executed, and the file types can be provided to the media player for processing that is described below in more detail.

### Exemplary Media Player UI

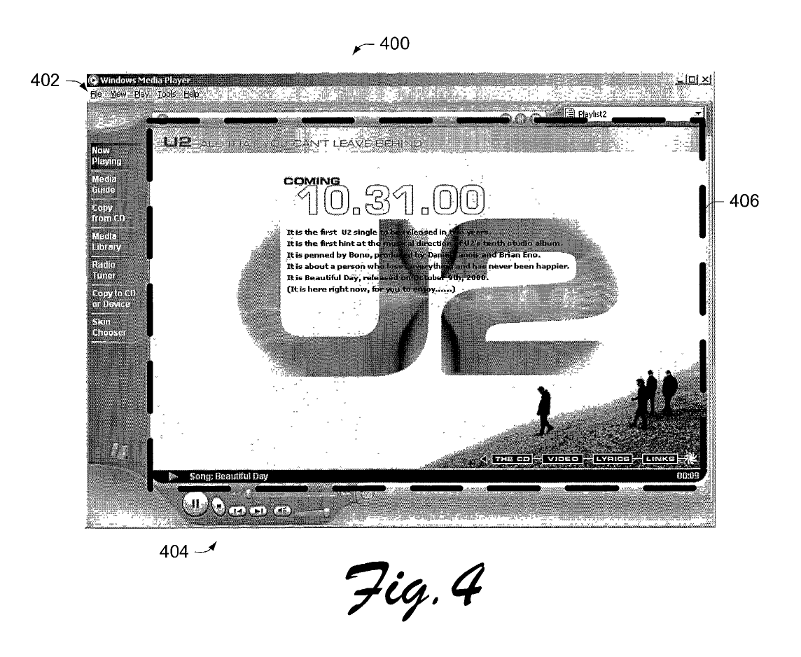

FIG. 4 shows one exemplary media player user interface (UI) 400 that comprises part of a media player executing on a client computer. The media player UI includes a menu 402 that can be used to manage the media player and various media content that can be played on and by the media player. Drop down menus are provided for file management, view management, play management, tools management and help management. In addition, a set of controls 404 are provided that enable a user to pause, stop, rewind, fast forward and adjust the volume of media that is currently playing on the media player.

A “Now Playing” area or pane 406 is provided in the UI and serves to enable media-specific content to be displayed for the user. The “Now Playing” area is highlighted with dashed lines. In the illustrated example, the U2 song “Beautiful Day” is playing and is accompanied by some visually pleasing art as well as information concerning the track.

In the embodiments about to be described, methods and systems are provided that can establish a relationship between media content (such as the U2 song “Beautiful Day”), and various other visual and audio content so that when a user downloads and plays media content, they are automatically presented with the various other content thereby enriching their experience. Media delivery techniques and systems are also described that permit and facilitate media delivery in a manner that can be transparent to the user. In some instances, all the user has to know how to do is click a link associated with the media content—everything else is done for them automatically!

### WMD File Overview

In one embodiment, an enhanced user experience is provided through the use of an innovative file referred to as a “WMD” file for Microsoft “Windows Media Download.” A WMD file can be thought of as a mechanism that enables a user to experience a “virtual album” through the use of a single file. Specifically, a WMD file enables delivery of a whole album's worth of content—not only just the music or music files. In addition to the innovative WMD file, a download process is specifically tailored to enhance the user experience by making the file acquisition process as easy as possible. A desirable way to do this is to make the download process a “one-click” process. Hence, a user need only, through the use of their browser, click a link associated with the WMD file and have the entire contents of the WMD file downloaded to their computer and organized so that their media player can automatically begin playing the content and providing the enhanced user experience.

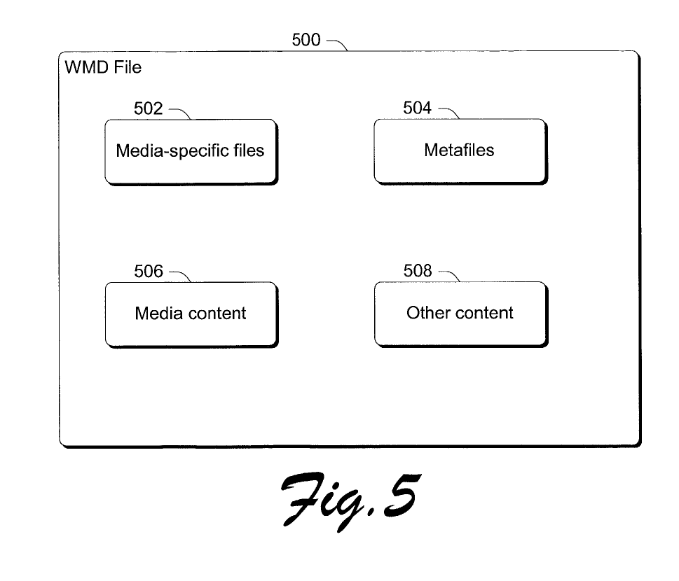

FIG. 5 shows an exemplary WMD file 500 and its exemplary constituent parts in accordance with one embodiment. In this example, WMD file 500 contains one or more media-specific files 502 that can be used to render a media-specific experience, such as a visual experience, on the media player. Media-specific files (having a .wmz extension) can come in the form of borders or skins. Borders and skins are discussed in more detail below in a section entitled “Borders and Skins”. In the described embodiment, borders and skins can be used by individuals, such as content owners, to define a unique user experience when playing media content on a media player. For example, in the FIG. 4 illustration, a border was used to define the content in the “Now Playing” portion of the media player UI in association with playing the U2 song “Beautiful Day.”

The WMD file can also contain one or more metafiles 504. Metafiles have an “.asx” extension and are embodied as extensible markup language (XML) files that contain elements or tags that can be used to include information associated with playlists, tracks, borders and skins. XML files and, specifically metafiles, are discussed below in more detail in a section entitled “Metafiles.”

The WMD file can also include one or more files associated with media content 506 itself. The media content can include any media content that is supported or supportable by any suitable media player. In the present example, the media content file extensions that are supported by the described media player include, without limitation, .wma, .wmv,.asf, .wav, .avi, .mpg, and .mp3. In addition to the above constituent parts, WMD file 500 can contain other content 508 that can be used in connection with renderable media content. Such other content can include, without limitation HTML, . . . The WMD file is embodied, in this example, as a Zip file.

### Borders and Skins

Borders and skins enable the creation of a custom graphical interface for packaged content (i.e. WMD files). Borders and skins can include elements such as images, interactive controls, and links to Web sites. Borders and skins can be used in instances where it is desirable to add additional value to packaged content, such as branding or advertising. In one embodiment, a media player can download the WMD file and then automatically display a skin or border when the packaged content is played.

Borders and skins are different, however, in the interface that is presented. Skins enable individuals to completely customize the interface of a media player, while a border is displayed in certain portions of a media player. In the example of FIG. 4, a border would be displayed in the “Now Playing” area 406. Skins and borders are, however, created using the same tools. These tools are described in U.S. patent application Ser. Nos. 09/773,446 and 09/773,457, the disclosures of which are incorporated by reference.

Exploring the concept of borders and skins and how they are created in more detail, consider the following. The skinning model described in the above patent applications and in some detail here, permits the creation of skins and borders that are adaptable, dynamic and not constrained in their layout. The skinning model provides all the tools one needs to make a custom user interface. In the context of Windows Media Player, the user interface can include buttons, slider bars, video windows, visualization windows, equalization bars, and so on.

A skin or border is typically composed of several files. Technically speaking, a skin or border comprises a group of files, with each file containing a specific kind of information that is utilized to render or in some way provide functionality for the skin or border.

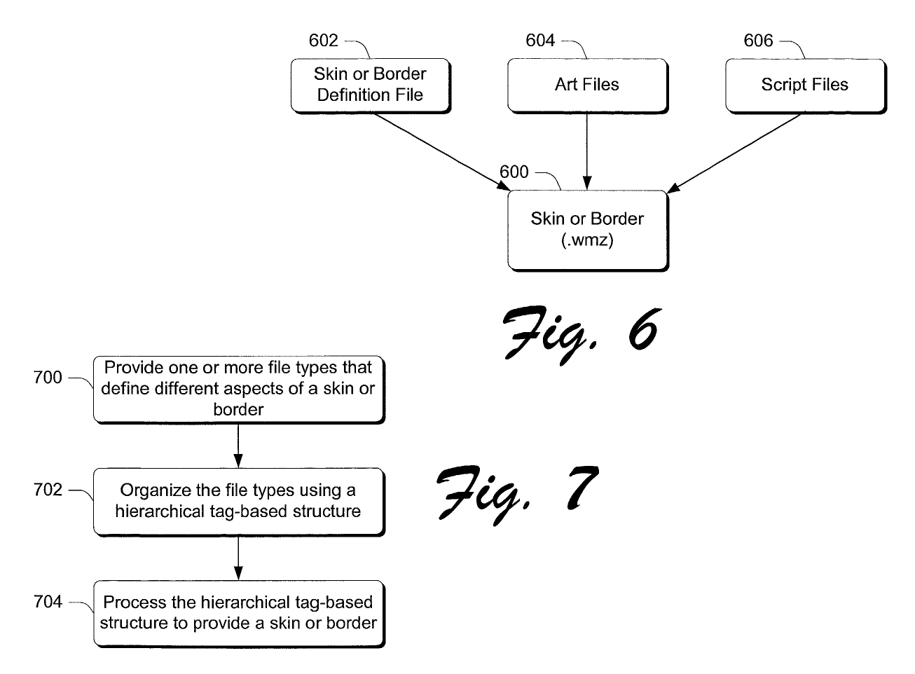

FIG. 6 shows a diagram that illustrates exemplary file types that can be utilized to make up or define a skin or border 600. In this example, the exemplary file types include a skin or border definition file 602, one or more art files 604, and one or more script files 606. It is to be appreciated and understood that script files 606 may or may not be used to make up a skin or border. The script files, as will become evident below, provide a means by which a skin can be interactive relative to various events. Script files can be used to do such things as view the lyrics to a song as the song plays, or alternate billboards to advertise a product.

Skin or border definition file 602 is a master file that defines how the other files will be used. In the illustrated embodiment, this is a text file and has the extension “.wms”. Skin definition files are analogous to traffic coordinators of a skin. Inside this file are the basic instructions for what the skin does and where the other pieces are. There is typically only one skin or border definition file for a skin or border. The skin or border definition file and related files can be collected and compressed into a compressed file, e.g. a Zip file. When this is the case, the extension is “.wmz” (Windows Media Zipped).

Instructions in the skin or border definition file are written in a hierarchical tag-based language. In the illustrated example, this language is XML, (i.e. eXtensible Markup Language), an extension to HTML. The XML in the skin or border definition file uses a set of special element tags or tag pairs to define parts of the skin user interface. For example, a <BUTTON> tag can define how a button will behave, where it will go, and what it will look like.

Each element tag has specific attributes or properties. In this document, the terms “attributes” and “properties” will be used interchangeably. For example, the BUTTON element has an Image attribute that defines where the picture of the button can be found. This is similar to HTML, where the BODY element will have a BgColor attribute which defines the background color of the body of the HTML page.

In the illustrated and described embodiment, the skin or border definition file follows a specific structure. You start with a Theme, create one or more Views, and then define each View with the user interface elements appropriate for the type of View you want to use.

The Theme element is the root element for a skin. There is only one Theme element in a skin or border definition file, and it is at the top level. Each Theme has at least one View. The View governs the particular image you see on the screen. There may be more than one View to enable switching back and forth. For example, you might want to have a large view for working with playlists, a medium view for watching visualizations, and a tiny view that fits in a corner of the screen.

Each View element can also have one or more Subview elements. A Subview element is similar to a view element and can be used for parts of a skin that you want to move around, hide, or show. For example, a Subview element might be used to create a sliding tray that pops out of your skin to display a graphic equalizer. Subviews are discussed in more detail in the Patent Applications incorporated by reference above.

Once Theme and View elements are defined, the View is populated with specific user interface elements. Any suitable user interface elements can be used. If an element can be seen by the user, it is called a control. Examples of controls can include, without limitation, the following controls: Buttons, Sliders, Custom Sliders, and Progress Bars, Text control, Video Windows, Visualization Windows, Playlist Windows, and SubView Windows.

Each skin or border also has one or more associated art files 604 . In the illustrated and described embodiment, there are three uses of art or art files in the skins and borders.

First, there are primary images. Primary images are what the users will see when a skin or border. The primary image is composed of one or more images that are created by specific skin controls. If you have more than one control, you can typically specify a “z-order”. The z-order defines which controls are displayed “in front” of other ones. There are also secondary images, such as a sliding tray, that do not display when a skin first appears, but that show up when the user takes some action. These follow the same rules as primary images, in that they are created with a set of controls. Second, there are mapping images. Mapping images are used for specific controls to specify which regions will respond to mouse clicks and to determine which controls receive which events. Third, there are alternate images that can be displayed when a user does something. For example, you can create an alternate image of a button that will be displayed only when the mouse hovers over the button. This is a good way to let users know what they can do, and also allows for a highly discoverable user interface. The art files can have any suitable type of format. The following format types are recognized by the Windows Media Player: BMP, JPG, GIF, and PNG. These uses for art files are discussed in more detail, and specific examples are given in the patent applications incorporated by reference above. For the sake of brevity, a more detailed explanation and the examples have been omitted.

Another type of file or files that can be, but need not be included in the skin or border definition is a script file(s) 606. In the illustrated and described example, script files in the form of Jscript files are utilized. It is to be appreciated and understood that any suitable script types can be utilized. Script files are typically text files and can be used to create elaborate functionality behind a skin. By creating functions in JScript, you can do almost anything imaginable with skins, as will be appreciated by those of skill in the art. For example, you could use a different playlist for every day of the week, but always have the same one on Friday.

The use of script files provides the capability for a skin or border to respond to various events. For example, through the use of script files, a skin or border can “do” something (i.e. react) when the user clicks on a button. Script files also enable a skin or border to respond to changes that happen to the application which, in the present case, is Windows Media Player. Such response might be one that changes, for example, with the progress of the media file that is playing.

FIG. 7 is a flow diagram that describes steps in a skin- or border-organizing method in accordance with one embodiment. The method can be implemented in any suitable hardware, software, firmware or combination thereof. In the described embodiment, aspects of the method are implemented in software.

Step 700 provides one or more file types that define different aspects of a skin or border. In the illustrated and described embodiment, the file types can include, without limitation, file types associated with art (termed “art files” above) that is used to define aspects of a skin's or border's appearance, and file types associated with script that provide for skin or border interactivity. It will be appreciated that the art files that can be utilized as described above can extend the look of a particular skin much further than was previously possible using static bitmaps. The script files provide the ability to impart functionality and interactivity to skins that was heretofore entirely absent from conventional skinning models. Step 702 organizes the file types using a hierarchical tag-based structure. In the illustrated and described embodiment, this step is implemented using an XML data structure. An example of a suitable XML data structure is described in the patent applications incorporated by reference above. The use of XML to represent or describe a skin or border constitutes a noteworthy and inventive departure from past methods. In the past, static bitmaps were used to impart a different look to a skin. The layout, feel and functionality of a skin, however, were fixed. By using XML to describe or define the skin or border, the skin or border designer is given the flexibility to robustly vary not only the look, but the layout, feel and functionality as well. Step 704 processes the hierarchical tag-based structure to provide a skin or border. An exemplary computer architecture that is capable of processing the hierarchical tag-based structure is described directly below.

The description below constitutes but one exemplary computer architecture or object model that is capable of implementing the inventive skinning and bordering techniques and methods. It is to be appreciated that departures from the described architecture can be made without departing from the spirit and scope of the claimed subject matter.

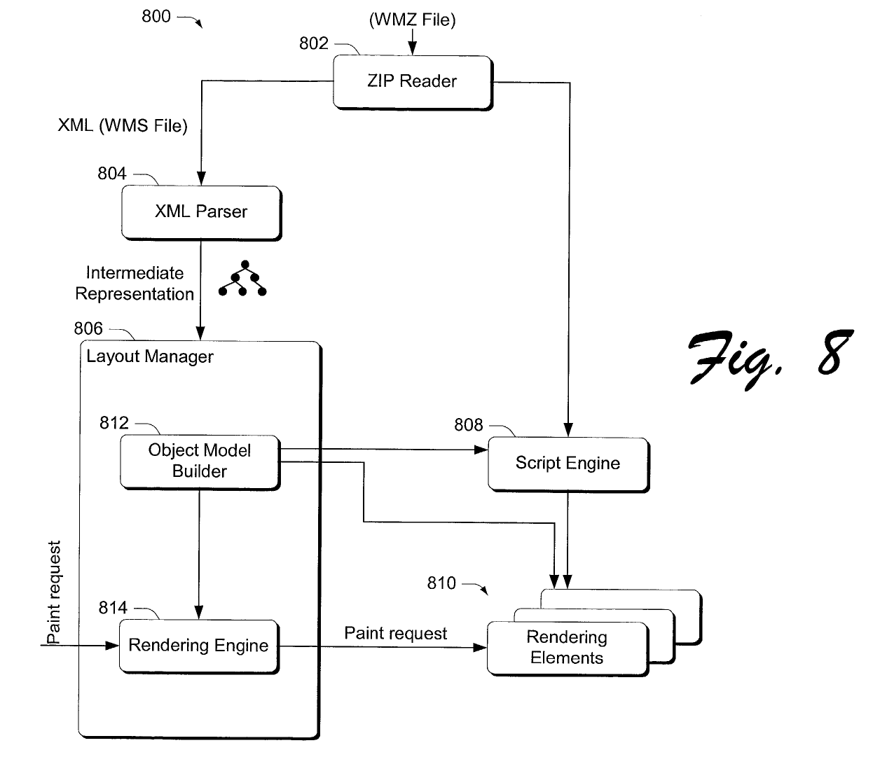

FIG. 8 shows a computer architecture generally at 800 that comprises a ZIP reader 802, a XML parser 804, a layout manager 806, a script engine 808, and one or more rendering elements 810. In this example, layout manager 806 is implemented as an ActiveX control and comprises an object model builder 812 and a rendering engine 814. This architecture is used to process the skin or border definition file and provide the software elements or components that cooperate to render a skin or border.

Recall that the skin definition file is defined as an XML file that can be compressed as a WMZ file. The layout manager 806 is given a file name to a skin or border definition file. The layout manager then instructs zip reader 802 to extract the XML and any files, including script files, that are included with the WMZ file. This extraction can be done directly to memory so that the files are not exploded into separate folders.

The skin or border definition file (in XML format) is received and processed by XML parser 804. Any suitable XML parser can be used. The parser parses the skin or border definition file to provide an intermediate representation in the form of a hierarchical data structure that describes the skin and its attributes. An exemplary hierarchical data structure in the form of a tree is diagrammatically represented adjacent the XML parser in FIG. 8.

The layout manager uses the intermediate representation to create a scriptable object model. Specifically, in this example, object model builder 812 processes the intermediate representation to provide one or more rendering elements 810 which are objects in the object model. The rendering elements are created in memory. To do this, the object model builder simply walks the intermediate representation looking for the appropriate XML tags, and then creates the necessary objects or rendering elements that are associated with the tags. The rendering elements represent components that have been specifically written or defined for the skin. For example, the rendering elements can comprise controls such as buttons and/or other elements of a skin. Examples of other rendering elements can include those associated with text, bitmaps, text boxes, lists of text, pop up menus, and play lists. All of the rendering elements are created by examining the specification in the XML.

If necessary—that is, if the XML specifies script in connection with the skin or border definition, the object model builder 812 instantiates script engine 808. After the script engine is instantiated, the layout manager provides the engine with a handle to the various rendering elements that have been created in memory. This is done so that the script engine can call the various rendering elements if and when various events require interaction with the rendering element.

Consider the following example: a user defines a skin in the form of a yellow duck. This skin has three rendering elements—one associated with a head, one associated with a body, and one associated with the duck's legs. Assume also that the user wishes for the duck's legs to walk whenever music is played by the media player. To impart this functionality or interactivity to the skin, the user authors script that essentially waits for an event associated with music playing. This event then triggers the script engine to cause the duck's legs to be redrawn by rendering engine 814 anytime music is playing and in manner that appears as if the duck is walking. The process for displaying images or art in the “Now Playing” area 406 of media player UI 400 in FIG. 4 is analogous.

Continuing, once the rendering elements (and, if necessary, the script engine) have been created and any necessary relationships established between the rendering elements and the script engine, properties for the individual rendering elements are populated. Additionally, any events that are specified in the XML for any of the rendering elements are provided to script engine 808. To populate the rendering element properties, in this example, the layout manager 806 processes the XML intermediate representation to identify various “name-value” pairs. The name-value pairs can include such things as “visible=true” etc. The layout manager or, more accurately object model builder 812 filters through all of the name-value pairs and, for each rendering element 810, it adjusts the properties as specified in the XML. So, for example, for song lyrics, the object model builder 812 might set a visible property as TRUE when the song is playing.

In addition to populating rendering element properties using the XML intermediate representation, there are also images (i.e. art files and the like) that are associated with various controls that are referenced in the XML, e.g. the image that is associated with the down control when it is pressed down. The object model builder 812 ascertains, from the XML intermediate representation, which image or art files are needed by the various controls and then passes this property to the appropriate rendering element. The rendering elements can then call the layout manager 806 to retrieve the appropriate files that they need.

The above-described set up process happens for each of the rendering elements. That is, the rendering elements are created, their properties are populated, and they are handed any image or art files or supplemental files that they need.

Once this phase is complete, object model builder 812 can also associate any script files with their associated skins. The object model accomplishes this task using the XML intermediate representation. Specifically, there is an attribute in the XML's VIEW element called scriptFile in which one or more script files can be specified. The object model builder reads this attribute and then requests the script files from zip reader 802. Accordingly, the script files can be fetched as needed. Recall that one or more script files were previously placed in memory by the zip reader and can be obtained from there. Script files can also be fetched from the ZIP file as needed. Once zip reader 802 provides the requested script files, layout manager 806 provides them to script engine 808. Accordingly, script engine 808 now has the code that it needs to impart the scripted functionality to the button, skin, or border.

In one embodiment, skins and borders are inextricably linked with the media content with which they are associated in the WMD file. Consider again, FIG. 5. There, WMD file 500 comprises media content 506 and media-specific files 502. The media-specific files 502 comprise the .wmz file that defines the skin or border described above. The media-specific files and the media content files (or content) are linked by virtue of a relationship that is defined in the metafile 504. By virtue of this relationship, any time the media content is played by the media player, the media-specific files 502 (i.e. the skin or border) can be automatically rendered and presented to the user. In the case of a skin, this can entail presenting an entirely new and different media player UI. In the case of the border, this can entail presenting an entirely new or different portion of an already rendered media player UI. In this manner, when the user plays a particular media or cause media to be played on their media player, they can be “flipped” into the associated skin or border. For example, assume that a user is browsing a Web page and there is a link to a particular piece of content. When the user clicks on the link, software in the browser notifies the media player, which then automatically accesses and downloads an associated WMD file. In addition, the media player automatically processes the WMD file and plays any media content files contained in the WMD file. In addition, if there are any skins or borders present in the WMD file, the media player causes them to be automatically displayed for the user. Thus, if the user were looking at their browser UI, the media player would, in this embodiment, automatically “flip” them to a media player that contained the skin or the border.

### Metafiles

As noted above, a metafile can be used to establish an inextricable link or relationship between media content and media-specific files such as skin and border files. This means that when the media content is played by a media player, the skin or border can be automatically displayed for the user so as to “flip” the user into a robust viewing/listening experience.

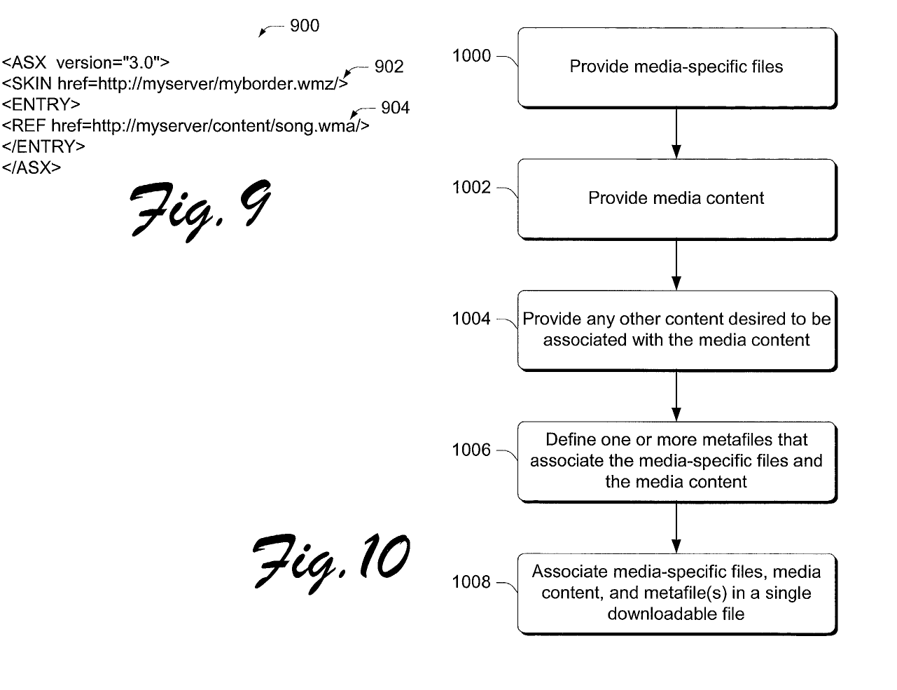

FIG. 9 shows an exemplary metafile 900 in the form of an XML file. The metafile essentially defines a playlist for the media player and references the media content that is contained in the WMD file. By using XML, the metafile provides the information that a media player uses to play and display content. The metafile is made up of various XML elements with their associated tags and attributes. Each XML element in a metafile defines a particular setting or action in the media player. A “SKIN” element or tag references a URL to a skin or border file and is used to display a skin or a border. In this example, the border file “myborder.wmz” is referenced by URL 902. WMZ files are described above in connection with FIG. 6. An “ENTRY” element or tag is used to define or reference specific content that is to be associated with the skin or border specified by the SKIN tag. In this example, the ENTRY tag contains a URL 904 that references a song file “song.wma.” This particular association thus instructs the media player to download or otherwise retrieve locally, the myborder.wmz skin file and render it in the “Now Playing” portion of the media player while the content “song.wma” is playing.

Hence, WMD files package a variety of data into a single downloadable file. For example, users can download a customized WMD file from a Web site. The WMD file can contain an entire album of music videos that also display advertising in the form of graphical branding and hyperlinks to an online music retailer site.

### WMD File Creation

In one embodiment, an innovative packaging tool is provided to assist individuals in packaging data together that can be used to greatly enhance the user experience when the user plays media on an enabled media player. Exemplary individuals who can use the innovative packaging tool include, without limitation, content owners who can now uniquely position their media content in the relevant consuming market. The packaging tool can be implemented in any suitable hardware, software, firmware, or combination thereof. In the illustrated example, the packaging tool is implemented in software.

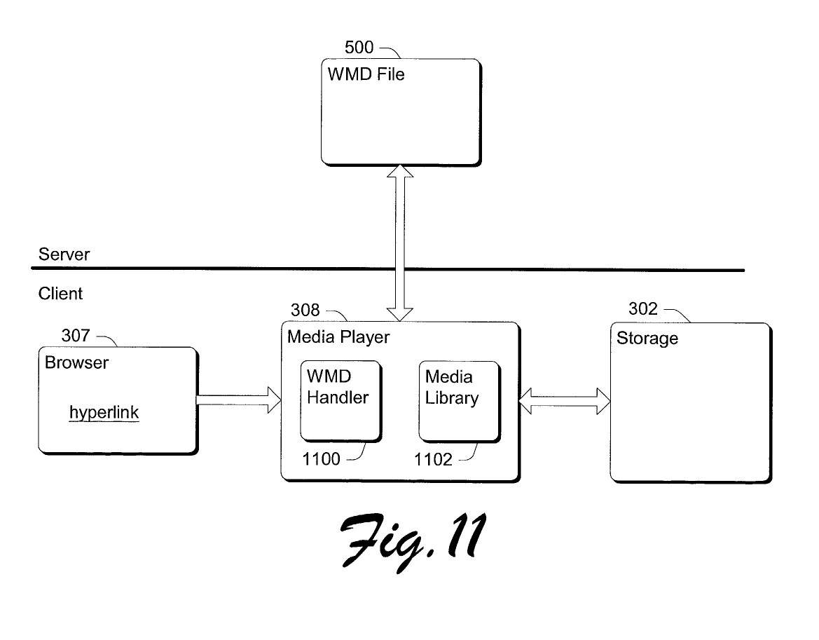

FIG. 10 is a flow diagram that describes steps in a media content packaging method in accordance with one embodiment. Step 1000 provides one or more media-specific files. As mentioned above, these media-specific files can comprise borders and skins. Exemplary techniques for defining borders and skins are described in the U.S. patent applications incorporated by reference above.

Step 1002 provides media content. This step is implemented by providing any suitable files that can be utilized by the media player of interest. Specific file type examples are given above. Step 1004 provides any other content that might be desirable to associate with the media content. Step 1006 defines one or more metafiles that associate the media-specific files and the media content. Exemplary metafiles can comprise XML files, a specific example of which is given in FIG. 9. Step 1008 associates the media-specific files, media content, and metafile(s) in a single downloadable file referred to above as a WMD file. Once the WMD file is created, it can be uploaded to a Web site so that all a user has to do to access the file and all its contents is to click a link to it.

### Accessing a WMD File

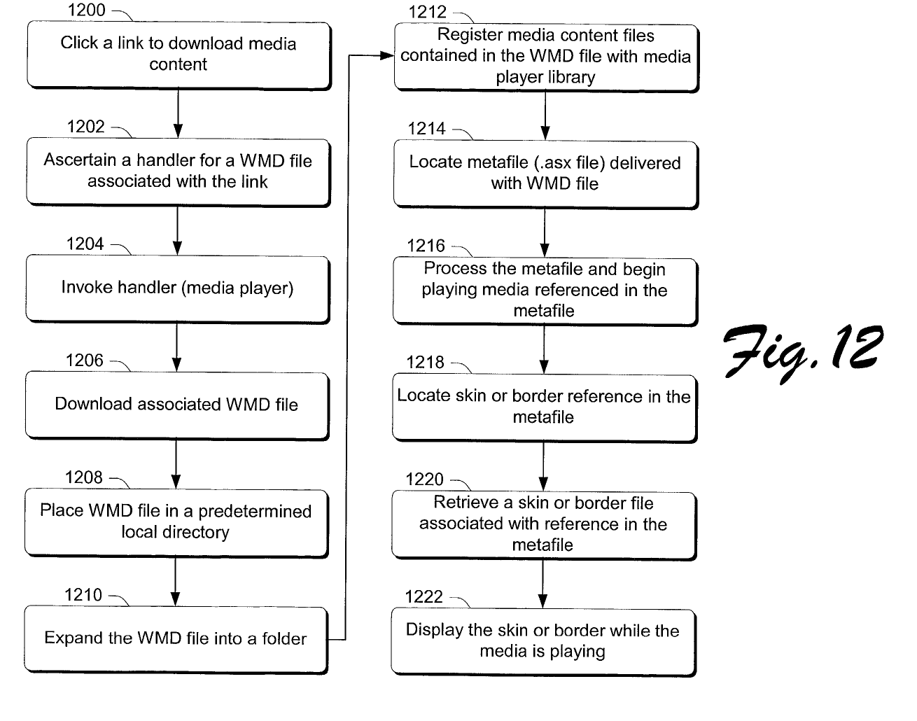

FIG. 11 shows a diagrammatic representation of how a WMD file can be accessed in accordance with one embodiment. After it is created, WMD file 500 is uploaded to a Web site managed by a server. Assume now that a user is using their Web browser 307 to browse the Internet. They click on a hyperlink that is associated with WMD file 500, or otherwise provide user-input that indicates they want to access, receive, or purchase media associated with a WMD file. In this example, the browser 307 ascertains a handler 1100 for the WMD file. The handler 1100 is notified because it previously registered for notifications whenever a link associated with a WMD file is clicked from the browser. The handler is implemented, in this embodiment, as part of media player 308. It is possible for the handler to be implemented as a standalone component. Handler 1100 automatically downloads the WMD file to the user's hard drive 302. It then expands the WMD file 500 into its constituent parts and looks for media content files 506 (FIG. 5) which it then registers in a media library 1102 associated with the player 308. Once the media content files are registered, the media player 308 looks for any metafiles (.asx files) that include track information and border (or skin) information. The player then plays the content referenced in the metafiles in the order specified therein, and in conjunction automatically displays any borders or skins that might be defined for the tracks or collection of tracks.

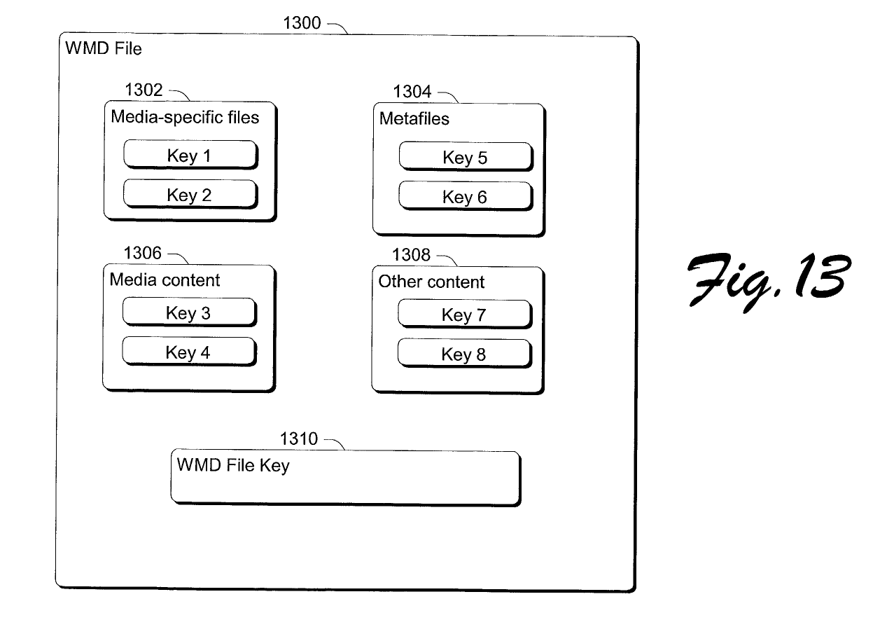

FIG. 12 is a flow diagram that describes steps in a multimedia access method in accordance with one embodiment. The method can be implemented in any suitable hardware, software, firmware, or combination thereof. In the illustrated example, the method can be implemented in software executing on a client computer.

In step 1200, a user clicks a link associated with media content. The media content can comprise any suitable media content that can be delivered over a network such as the Internet. In the embodiment described in this document, the media content comprises songs that can be delivered in digitized form over the network. The media content is desirably delivered in a single downloadable package that contains various items in addition to the songs. Examples of such other items are discussed above and include such things as art, skins, borders, and the like. In the described embodiment, the single downloadable package is a WMD file.

The link can be provided as part of a Web site managed by a content provider that sells albums, CDs, or collections of tracks. When a user clicks the link, step 1202 ascertains a handler for a WMD file associated with the link. In this step, the WMD handler has previously registered with the user's browser for notifications when links that correspond to WMD files are selected by the user. In this particular case, the WMD handler comprises part of the media player. Step 1204 invokes the handler (media player) and step 1206 downloads, via the handler, the associated WMD file to a client computer. The WMD file can be automatically downloaded and processed on the client computer in any suitable way. In one embodiment, downloading and processing of the WMD file takes place automatically without any input or intervention from the user. In this manner, the constituent parts of the WMD file discussed above can be organized on the client and the media player can automatically play any associated media automatically, without any intervention from the user. The automatic playing of the media also desirably includes retrieving and rendering any additional content, such as skins, borders, and the like so that the user experience is greatly enhanced. The following steps illustrate but one way of processing a WMD file so that downloading and content playing take place without any user intervention.

Step 1208 takes the downloaded WMD file and places it in a predetermined local directory. For example, the media player can place the WMD file in a “Virtual Album” directory on the client's local hard drive. Step 1210 expands the WMD file into a folder. This step is implemented by unzipping the WMD file and placing the constituent files (i.e. media-specific files (.wmz files), metafiles (.asx files) and media content files) into an appropriate folder. For example, the WMD file might be unpacked to place the constituent files in a subdirectory of the “Virtual Album” directory. In step 1212, the media player looks for any media content files that were contained in the WMD file and registers them by adding them to its own media library. Step 1214 locates any metafiles (.asx files) that were delivered with the WMD file. Recall that the metafiles can contain the playlist for the media content as well as reference any skins or borders that should be displayed with the content. FIG. 9 shows an exemplary portion of an .asx file. In step 1216, the media player processes the metafile and begins playing media referenced in the metafile. Contemporaneously, the media player locates any skin or border referenced in the meta file (step 1218), retrieves the referenced skin or border (step 1220), and displays the skin or border while the media is playing. Steps 1216-1222 can take place in a manner in which their effects appear to be generally simultaneous to the user.

It will be appreciated that skins or borders can be locally retrieved by step 1220, or can be retrieved over the Web. It will also be appreciated that the implementation of step 1222 (i.e. the display of the skin or border) can be different depending on what is to be displayed. If a skin is to be displayed, then an entirely new media player UI can be displayed. This new media player UI can have any form, shape, appearance and the like. If a border is to be displayed, then only a portion of a standard media player is modified to present the border.

Advantages of at least some of the WMD file embodiments discussed above include that a single-click downloads, extracts, and catalogs multiple files to user's computer. Additionally, content plays immediately after being downloaded, without any intervention from the user. This is advantageous from the standpoint of making it easier for users to acquire and enjoy media content. Users no longer have to know anything about the downloading process, e.g. where to place files, what files to download, how to provide those files to the proper media player and the like. This can all be done automatically for them. Further, customized borders and skins provide an opportunity for displaying advertising and branding information. This greatly enhances the value that can be provided by content owners. Packaged playlists are automatically cataloged in a media player's library so that a user can make use of them almost immediately. Additionally, a user can be redirected to a Web site from within a media player to a site that is related to the content that is being played, i.e. to a Web site for a purchasing experience. Furthermore, multiple audio and video file types are supported for packaging and multiple files can be downloaded in one package thus making for a more rich and robust user experience.

### Digital Rights Management

Recall from the earlier discussion that the content within a WMD file can be managed through the use of digital rights management techniques. This takes place through the use of digital rights management modules that can reside on one or both of a server that provides the WMD files, and a client that receives the WMD files.

Digital rights management (DRM) is a type of server software developed to enable secure distribution, and perhaps more importantly, to disable illegal distribution of paid content over the Web. DRM technologies are being continually developed as a means of protection against the online piracy of commercially marketed material, which has proliferated through the widespread use of such things as peer-to-peer file exchange programs. In general, DRM products are typically turnkey packages that include everything needed for the operation, such as, for example, server software and user plug-ins.

FIG. 13 illustrates multiple different ways in which digital rights management techniques can be used to manage a WMD file 1300 and content within the WMD file. The techniques about to be described can be used by themselves or in various combinations with these and other DRM techniques.

To begin with, DRM techniques can be used to protect the WMD file itself. One exemplary way of doing this is to encrypt the WMD file and associate a WMD file key 1310 with it. The WMD file key 1310 can be used to decrypt the WMD file and gain access to the file's contents. Only authorized users can be given access to the WMD file key and the key itself can be non-transferrable to other computers. Thus, for example, the WMD file key might itself be encrypted with a user's public key and sent to the user who properly purchases the WMD file. Then, by using the user's private key, the media player can decrypt the encrypted WMD file key so that the WMD file can itself be decrypted. By encrypting the WMD file, the file can then be used without extracting it into its constituent parts.

In addition to or in place of the above-described technique, the various separate constituent parts of a WMD file can be protected through DRM techniques. One way of doing this is to encrypt the content within the individual constituent parts with a key that is provided only to authorized purchasers. Provision of the key can take place substantially as described above.

Consider, for example media-specific files 1302. These files can represent great value to the content provider insofar as enhancing the user's experience. In order for an enhanced experience, (e.g. being able to view lyrics, trivia, art and the like) associated with particular media content, the user might be required to pay an additional fee. In this case, when the user pays the additional fee, they are provided with one or more keys that can be used by their media player to unlock content provided by the media-specific files. So, for example, a user might be able to additionally purchase a new border or skin that provides art and interactive capabilities that can be experienced while they are listening to their new songs.

Consider additionally metafiles 1304. Here, DRM techniques can be used to prevent unauthorized users from gaining access to the .asx files that contain the data used by the media player to organize and render content. Consider further the media content 1306 itself. DRM techniques can be used to protect the content from unauthorized users. Such techniques can also be used to implement predelivered and progressive licenses. Specifically, individual content files within the media content 1306 can be encrypted with different keys. A user might pay one fee to access keys that allow them to decrypt a first set of content (e.g. the first 10 tracks of a CD), and then pay an additional fee to access an additional key that allows them to decrypt two additional bonus tracks.

Consider further that any other content 1308 that can be provided within a WMD file can be protected through the use of DRM techniques.

It is to be appreciated and understood that DRM techniques vary widely and that the above-described exemplary techniques are not intended to limit the DRM techniques that can be employed with the inventive WMD files. Accordingly, any suitable DRM techniques can be utilized without departing from the spirit and scope of the claimed subject matter.

### Conclusion

The embodiments described above enable media content to be efficiently packaged and delivered, via a network, in a manner that can greatly enhance the user experience. A packaging approach provides a downloadable file that contains different constituent parts that can be processed by a software-implemented media player to provide a user with not only media content, but additional content that adds value to the media content and enriches the user's experience. A download approach provides for the downloadable file to be link-accessed by a user, and automatically downloaded, cataloged, and experienced by the user without any more user intervention other than clicking on a particular link that is associated with the downloadable file.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method of providing a user experience when playing media on a media player comprising:
downloading a file that contains at least one media-specific file configured to provide a user interface, and media content with which the user interface is associated;
playing the media content with a media player; and
automatically displaying the user interface when the media content is played with the media player.

2. The method of claim 1, wherein said automatically displaying comprises displaying the user interface as part of the media player.

3. The method of claim 1, wherein said automatically displaying comprises displaying the user interface to comprise the media player.

4. The method of claim 1, wherein said at least one media-specific file comprises multiple files including a definition file that defines how other associated files are to be used, and art files containing images that are associated with the user interface.

5. The method of claim 4, wherein said at least one media-specific file comprises least one script file for scripting.

6. The method of claim 4, wherein said at least one media-specific file comprises least one script file that provides a capability for the user interface to respond to events.

7. The method of claim 1 further comprising prior to said playing, using a digital rights management technique to access one or more of the downloaded file, media-specific file, and media content.

8. One or more computer-readable media having computer readable instructions thereon which, when executed by a computer, cause the computer to:
download a file that contains at least one media-specific file configured to provide a user interface, and song files with which the user interface is associated;
play the song files with a media player; and
automatically display the user interface when the song files are played with the media player.

9. A media player comprising software code that is configured to:
download a file that contains at least one media-specific file configured to provide a user interface, and media content with which the user interface is associated;
play the media content; and
automatically display the user interface on at least a portion of a media player user interface when the media content is played with the media player.

10. The media player of claim 9, wherein the software code is configured to automatically display the user interface to comprise the entire media player user interface.

11. The media player of claim 9, wherein the software code is configured to use a digital rights management technique to access one or more of the downloaded file, media-specific file, and media content prior to playing the media content.

12. A method of organizing media content comprising:
providing at least one media-specific file that is configured to provide a user interface on at least a portion of a media player;
providing at least one media content file configured for play on the media player; and
associating the one media-specific file with the one media content file such that any time the one media content file is played on the media player, the one media-specific file is processed to automatically display the user interface on at least a portion of the media player.

13. The method of claim 12 further comprising protecting at least one of the media-specific file and the media content file using a digital rights management technique.

14. The method of claim 12, wherein said associating comprises establishing a relationship between the one media-specific file and the one media content file using an XML data structure.

15. The method of claim 12, wherein the one media content file comprises at least one song file.

16. The method of claim 12, wherein the one media content file comprises multiple song files.

17. The method of claim 12, wherein said associating comprises packaging the one media-specific file and the one media content file in a single downloadable file.

18. One or more computer-readable media having computer-readable instructions thereon which, when executed by a computer, implement the method of claim 12.

19. A method of organizing media content comprising:
providing at least one media-specific file that is configured to provide a media player user interface;
providing at least one media content file configured for play on a media player; and
associating the one media-specific file with the one media content file such that any time the one media content file is played on the media player, the one media-specific file is processed to automatically display the media player user interface.

20. The method of claim 19, wherein said associating comprises establishing a relationship between the one media-specific file and the one media content file using an XML data structure.

21. The method of claim 19, wherein the one media content file comprises at least one song file.

22. The method of claim 19, wherein the one media content file comprises multiple song files.

23. The method of claim 19, wherein said associating comprises packaging the one media-specific file and the one media content file in a single downloadable file.

24. One or more computer-readable media having computer-readable instructions thereon which, when executed by a computer, implement the method of claim 19.

25. A method of organizing content for a user experience comprising:
providing multiple different files that define different aspects of a media player user interface, at least some files being associated with media content and at least some other files being associated with visual content; and
organizing the files for sending over a network to a client computer, said organizing using a hierarchical tag-based structure to establish a relationship between the files such that when the media content is played by a media player, the visual content is automatically displayed as at least part of the media player user interface.

26. The method of claim 25, wherein when the media content is played by a media player, the visual content is automatically displayed to comprise an entire media player user interface.

27. The method of claim 25, wherein said organizing comprises using a hierarchical tag-based structure comprising an XML data structure.

28. A method of accessing media content comprising:
displaying a link to media content;
responsive to a user clicking on the link, automatically downloading a file that contains at least one media content file and at least one file that is configured to provide at least a portion of a media player user interface that is specific to media content associated with the one media content file;
playing the media content on a media player; and
responsive to said playing, automatically displaying said portion of the media player user interface.

29. The method of claim 28, wherein said portion comprises an entire media player user interface.

30. The method of claim 28, wherein said automatically displaying comprises automatically flipping from a non-media player user interface to a media player user interface.

31. One or more computer-readable media having computer readable instructions thereon which, when executed by a computer, cause the computer to:
display a link to media content;
responsive to a user clicking on the link, automatically download a file that contains at least one media content file and at least one file that is configured to provide at least a portion of a media player user interface that is specific to media content associated with the one media content file;
play the media content on a media player; and
responsive to playing the media content, automatically display said portion of the media player user interface.

32. A media delivery mechanism comprising:
a single file comprising:
one or more media content files associated with content that can be played on a media player;
one or more content-specific files that can be processed to provide a content-specific user interface associated with content that is played on the media player; and
a relationship between the one or more media content files and the one or more content-specific files such that a content-specific user interface is displayed on a computer when the content associated with the one or more media content files is played on the media player.

33. The media delivery mechanism of claim 32, wherein said relationship is established by a metafile that comprises part of the single file.

34. The media delivery mechanism of claim 33, wherein said metafile comprises an XML data structure that establishes said relationship.

35. The media delivery mechanism of claim 32, wherein the content-specific user interface comprises only a portion of a media player user interface.

36. The media delivery mechanism of claim 32, wherein the content-specific user interface comprises an entire media player user interface.

37. The media delivery mechanism of claim 32, wherein the relationship causes the same content-specific user interface to be displayed for multiple media content files.

38. The media delivery mechanism of claim 32, wherein said one or more media content files comprise song files.

39. A method of providing a media delivery mechanism comprising:
providing one or more media-specific files, the files being configured to provide at least a portion of a media player user interface, said portion being associated with specific media that can be played on a media player;
providing one or more media content files associated with media that can be played on a media player embodying the media player user interface, said media content files comprising the specific media with which the media player user interface portion is associated; and
defining one or more metafiles that associate the one or more media-specific files with the one or more media content files, the one or more metafiles being configured for processing such that when the media player plays media associated with a media content file, the media player automatically renders the media player user interface portion.

40. The method of claim 39 further comprising associating the one or more media-specific files, the one or more media content files, and the one or more metafiles in a single downloadable file.

41. The method of claim 40 further comprising protecting one or more of the media-specific files, media content files, metafiles, and single downloadable file using one or more digital rights management technique.

42. The method of claim 40 further comprising uploading the single downloadable file to a Web site.

43. The method of claim 40, wherein said one or more metafiles associate said files using an XML data structure.

44. The method of claim 40, wherein said providing of the one or more media-specific files comprises providing one or more media-specific files that are configured to provide an entire media player user interface.

45. A method of providing media content over a network comprising:
receiving input requesting that a file be sent to a client computer, the file comprising:
one or more media content files associated with content that can be played on a media player on the client computer,
one or more media-specific files that can be processed to provide a content-specific user interface, and
one or more metafiles that establish a relationship between the one or more media content files and the one or more media specific files such that a content-specific user interface is displayed when the content is played on the media player; and
sending the requested file to the client computer.

46. The method of claim 45, wherein the content-specific user interface comprises only a portion of a media player user interface.

47. The method of claim 45, wherein the content-specific user interface comprises an entire media player user interface.

48. The method of claim 45, wherein the one or more metafiles comprise at least one XML data structure that establishes said relationship.

49. The method of claim 45, wherein the media content files comprise at least one song file.

50. A server computer comprising:
at least one computer-readable media; and
computer-readable instructions resident on the computer-readable media which, when executed by the server, cause the server to:
maintain multiple files, each file comprising:
one or more media content files associated with content that can be played on a media player on the client computer,
one or more media-specific files that can be processed to provide a content-specific user interface, and
one or more metafiles that establish a relationship between the one or more media content files and the one or more media specific files such that a content-specific user interface is displayed when the content is played on the media player;
receive input requesting that one or more of the multiple files be sent to a client computer; and
send the one or more requested files to the client computer.

51. A method for playing media content on a media player comprising:
receiving a file with a client computer, the file comprising:
one or more media content files associated with content that can be rendered on a media player on the client computer,
at least one media-specific file that can be processed to provide a content-specific user interface, and
at least one metafile that establishes a relationship between the media content files and the media-specific files such that a content-specific user interface is provided when the content associated with the content files is played on the media player;
playing content associated with the content files on the media player embodied on the client computer; and
while playing the content on the media player, displaying the content-specific user interface.

52. The method of claim 51, wherein the content-specific user interface comprises only a portion of a media player user interface.

53. The method of claim 51, wherein the content-specific user interface comprises an entire media player user interface.

54. One or more computer-readable media having computer-readable instructions thereon which, when executed by a computer, cause the computer to implement the method of claim 51.

55. A media player comprising software code that is configured to:
receive a file with a client computer, the file comprising:
one or more media content files associated with content that can be rendered on the media player,
at least one media-specific file that can be processed to provide a content-specific user interface, and
at least one metafile that establishes a relationship between the media content files and the media-specific files such that a content-specific user interface is provided when the content associated with the content files is played on the media player;
play content associated with the content files; and
while playing the content, display the content-specific user interface.

56. A method for processing media content comprising:
receiving a file with a client computer, the file comprising:
one or more media content files associated with content that can be rendered on a media player on the client computer,
at least one media-specific file that can be processed to provide a content-specific user interface, and
at least one metafile that establishes a relationship between the media content files and the media-specific files such that a content-specific
user interface is provided when the content associated with the content files is played on the media player; and
automatically organizing the received files in one or more directories on a client computer hard drive without any intervention from a user, the files being organized in a manner that permits audio and visual content to be played on a media player without any intervention from the user.

57. The method of claim 56 further comprising automatically playing audio content on the media player, and while playing said audio content and responsive thereto, automatically displaying the content-specific user interface.

58. The method of claim 56 further comprising automatically playing audio content on the media player, and while playing said audio content and responsive thereto, automatically displaying the content-specific user interface to comprise only a portion of a media player user interface associated with the media player.

59. The method of claim 56 further comprising automatically playing audio content on the media player, and while playing said audio content and responsive thereto, automatically displaying the content-specific user interface to comprise an entire media player user interface associated with the media player.

60. One or more computer-readable media having computer-readable instructions thereon which, when executed by a computer, cause the computer to implement the method of claim 56.

61. A media player comprising software code configured to cause the media player to:
receive a file, the file comprising:
one or more media content files associated with content that can be rendered on the media player,
at least one media-specific file that can be processed to provide a content-specific user interface, and
at least one metafile that establishes a relationship between the media content files and the media-specific files such that a content-specific user interface is provided when the content associated with the content files is played on the media player; and
automatically organize the received files in one or more directories on a client computer hard drive without any intervention from a user, the files being organized in a manner that permits audio and visual content to be played on the media player without any intervention from the user.

62. The media player of claim 61, wherein the software code further causes the media player to automatically play audio content, and while playing said audio content and responsive thereto, automatically display the content-specific user interface.

63. A method of playing media content comprising:
receiving a file with a client computer, the file comprising:
one or more media content files associated with content that can be played on a media player on the client computer,
at least one media-specific file that can be processed to provide a content-specific user interface, and
at least one metafile that establishes a relationship between the media content files and the media-specific files such that a content-specific user interface is provided when the content associated with the content files is played on the media player; and
automatically playing content associated with the one or more media content files using a media player embodied on the client computer; and
while playing said content, automatically displaying the content-specific user interface.

64. The method of claim 63, wherein said displaying comprises doing so without any intervention from a user.

65. A media player comprising software code which, when executed by a computer, causes the media player to implement the method of claim 63.

66. A method for playing media content comprising:
receiving a user input;
responsive to the user input and without any additional user intervention, automatically:
downloading, on a client computer, multiple files associated with media content;
organizing the multiple files on a hard drive of the client computer;
playing media associated with at least some of the files using a media player embodied on the client computer; and
rendering at least a portion of the media player to include visual content that is specific to the playing media and associated with at least some of the files that were downloaded.

67. The method of claim 66, wherein said rendering comprises rendering the entire media player to include the visual content.

68. A media player comprising software configured to:
receive an input;
responsive to the input and without any user intervention, automatically:
download, on a client computer, multiple files associated with media content;
play media associated with at least some of the files using a media player embodied on the client computer; and
render at least a portion of the media player to include visual content that is specific to the playing media and associated with at least some of the files that were downloaded.
